(19) United States
(12) Patent Application Publication
(10) Pub. No.: US 2012/0307195 A1
(43) Pub. Date: Dec. 6, 2012

(54) MAGNETIC PULLING TYPE FREE HANGING FRAME FOR EYEGLASSES

(75) Inventor: Mao Ching Lin, Shenzhen (CN)

(73) Assignee: Shenzhen Versuvio Optik, Ltd., Shenzhen, Guangdong (CN)

(21) Appl. No.: 13/056,714

(22) PCT Filed: Jun. 22, 2010
(86) PCT No.: PCT/CN2010/074239

§ 371 Date: Jan. 31, 2011

(30) Foreign Application Priority Data
Jun. 23, 2009 (CN) 200920304901.4

(51) Int. Cl. G02C 9/00

(52) U.S. Cl. 351/57

(57) ABSTRACT

This invention is a magnetic pulling type free hanging frame, the pulling type free hanging frame comprises at least a plastic ring and the lens contained in said plastic ring; said plastic ring includes a positioning mechanism which coordinates with the main eyeglass frame; the pulling type free hanging frame also includes at least a magnet, said magnet is inlayed in said plastic ring. The beneficial effects include: this invention has a simple processing technique; making use of plastic ring helps reduce the weight of the hanging frame, that is, the overall weight of the glasses, and then reduce the pressure on the nose caused by the pair of glasses; inlaying magnets in the ring provides enough magnetic force; the bridge has an elastic mechanism which provides a higher matching degree when the hanging frame is fixed to the main eyeglass frame, and the bridge has an articulated mechanism enable the left and the right plastic ring to symmetrically fold back together, so that the hanging frame takes less volume space for storage; and this pulling type free hanging frame can directly fits with the original eyeglass frames without installing any magnet in the eyeglass frames, so using this hanging frame to fit with the original eyeglass frames would not destroy the overall appearance.

### BACKGROUND OF THE INVENTION

1. Field of the Invention

This invention relates to the field of glasses technology, more specifically, this invention relates to a magnetic pulling type free hanging frame for eyeglasses.

2. Description of Related Art

The eyeglass has the following effects: (1) correcting ametropia which assists eyes to work and helps to avoid the vision degradation and the asthenopia caused by the ametropia, and improves or recovers the working abilities of the eyeballs to or near to the normal condition; (2) recovering the abilities of adjusting focus and light intensity of the eyeballs; (3) increasing the adjusting abilities so that the old and the patients with presbyopia can have normal myopia; (4) protecting against strong light or other harmful light, wind and sand, etc. So eyeglass helps a lot in life and in work and eyeglass is one of the necessities now.

In different situation, different functional glasses are needed, so eyeglasses with the hanging frame are accepted by more and more people. In the present, a pair of glasses with the hanging frame includes a metal main frame and a metal hanging frame, and there are magnets separately in the main frame and the hanging frame so that the causing magnetic force can fasten the hanging frame to the main frame. However because the hanging frame is metal and there are magnets in the hanging frame, the present hanging frame has a too large weight; and the more weight in the hanging frame requests correspondingly more magnets in the main frame, so that the overall weight of the main frame and the hanging frame of a pair of glasses is too much for the nose to bear. In addition, the magnets set separately in the main frame and the hanging frame would collide with each other, and because of the hardness, these magnets would easily scratch the electroplated coating of the main frame or the hanging frame, which would destroy the appearance of the main frame or the hanging frame.

### SUMMARY OF THE INVENTION

To resolve the present technical problems, this invention provides a magnetic pulling type free hanging frame for eyeglasses, and makes use of the magnets and the positioning mechanism in or on the plastic ring to fit and fix the hanging frame to the main eyeglass frame. This invention is light in weight, is easy to use, and totally requires no change in the original main eyeglass frame.

To resolve the present technical problems, this invention provides a magnetic pulling type free hanging frame, the pulling type free hanging frame comprises at least a plastic ring and the lens contained in said plastic ring; said plastic ring includes a positioning mechanism which coordinates with the main eyeglass frame; the pulling type free hanging frame also includes at least a magnet, said magnet is inlayed in said plastic ring.

Further improvements of this invention include:

There are multiple said magnets which are separately set in the plastic ring.

Said positioning mechanism contains multiple positioning blocks or a positioning ring.

The pulling type free hanging frame includes a bridge which is used to connect the two plastic rings.

Said bridge includes an elastic mechanism and an articulated mechanism.

Said bridge includes two spring posts which are set separately on the two ends of the bridge and a link bar between the two spring posts.

Said bridge includes two connection posts which are set separately on the two ends of the bridge and a connection spring between the two connection posts.

Said bridge is a metal connection bar.

Said bridge includes two fixed blocks which are set separately on the two ends of the bridge and a connection block between the two fixed blocks, and the two ends of said connection block connect separately to the free ends of the two fixed blocks.

Said bridge and said plastic rings are integrated into one body.

Compared with the prior art, the beneficial effects of this invention include: this invention has a simple processing technique; making use of plastic ring helps reduce the weight of the hanging frame, that is, the overall weight of the glasses, and then reduce the pressure on the nose caused by the pair of glasses; inlaying magnets in the ring provides enough magnetic force; the bridge has an elastic mechanism which provides a higher matching degree when the hanging frame is fixed to the main eyeglass frame, and the bridge has an articulated mechanism enable the left and the right plastic ring to symmetrically fold back together, so that the hanging frame takes less volume space for storage; and this pulling type free hanging frame can directly fits with the original eyeglass frames without installing any magnet in the eyeglass frames, so using this hanging frame to fit with the original eyeglass frames would not destroy the overall appearance.

To resolve the present technical problems, this invention provides a pair of glasses, the pair of glasses comprises a main eyeglass frame with metal rim line and a magnetic pulling type free hanging frame; said magnetic pulling type free hanging frame fits with said main eyeglass frame; the magnetic pulling type free hanging frame comprises at least a plastic ring and the lens contained in said plastic ring; said plastic ring includes a positioning mechanism which coordinates with the main eyeglass frame; the pulling type free hanging frame also includes at least a magnet, said magnet is inlayed in said plastic ring.

Further improvements of this invention include:

There are multiple said magnets which are separately set in the plastic ring.

Said positioning mechanism contains multiple positioning blocks or a positioning ring.

The pulling type free hanging frame includes a bridge which is used to connect the two plastic rings.

Said bridge includes an elastic mechanism and an articulated mechanism.

Said bridge includes two spring posts which are set separately on the two ends of the bridge and a link bar between the two spring posts.

Said bridge includes two connection posts which are set separately on the two ends of the bridge and a connection spring between the two connection posts.

Said bridge is a metal connection bar.

Said bridge includes two fixed blocks which are set separately on the two ends of the bridge and a connection block between the two fixed blocks, and the two ends of said connection block connect separately to the free ends of the two fixed blocks.

Said bridge and said plastic rings are integrated into one body.

Compared with the prior art, the beneficial effects of this invention include: this invention has a simple processing technique; making use of plastic ring helps reduce the weight of the hanging frame, that is, the overall weight of the glasses, and then reduce the pressure on the nose caused by the pair of glasses; inlaying magnets in the ring provides enough magnetic force; the bridge has an elastic mechanism which provides a higher matching degree when the hanging frame is fixed to the main eyeglass frame, and the bridge has an articulated mechanism enable the left and the right plastic ring to symmetrically fold back together, so that the hanging frame takes less volume space for storage; and this pulling type free hanging frame can directly fits with the original eyeglass frames without installing any magnet in the eyeglass frames, so using this hanging frame to fit with the original eyeglass frames would not destroy the overall appearance.

### BRIEF DESCRIPTION OF THE DRAWINGS

FIG. 1 is a structural schematic diagram of the magnetic pulling type free hanging frame of this invention with only one eye ring;

FIG. 2 is another structural schematic diagram of the magnetic pulling type free hanging frame;

FIG. 3 is a structural schematic diagram of the one body combined said plastic rings and said bridge;

FIG. 4 is a structural schematic diagram of said bridge including two connection springs and a link bar between the two connection springs;

FIG. 5 is a structural schematic diagram of said bridge including two connection posts and a connection spring between the two connection posts;

FIG. 6 is a structural schematic diagram of said bridge which is a metal bar;

FIG. 7 is a structural schematic diagram of said bridge including two fixed blocks and a connection block between the two fixed blocks;

FIGS. 8a to 8c are schematic diagrams of front view, vertical view, and folding-state view of FIG. 6;

FIG. 9 is a structural schematic diagram of the glasses with a main eyeglass frame and a peripheral magnetic pulling type free hanging frame of this invention; and

FIG. 10 is another structural schematic diagram of the glasses of this invention.

### DETAILED DESCRIPTION OF PREFERRED EMBODIMENTS

Further description of this invention is made now through the embodiments of the invention and the accompanying drawings.

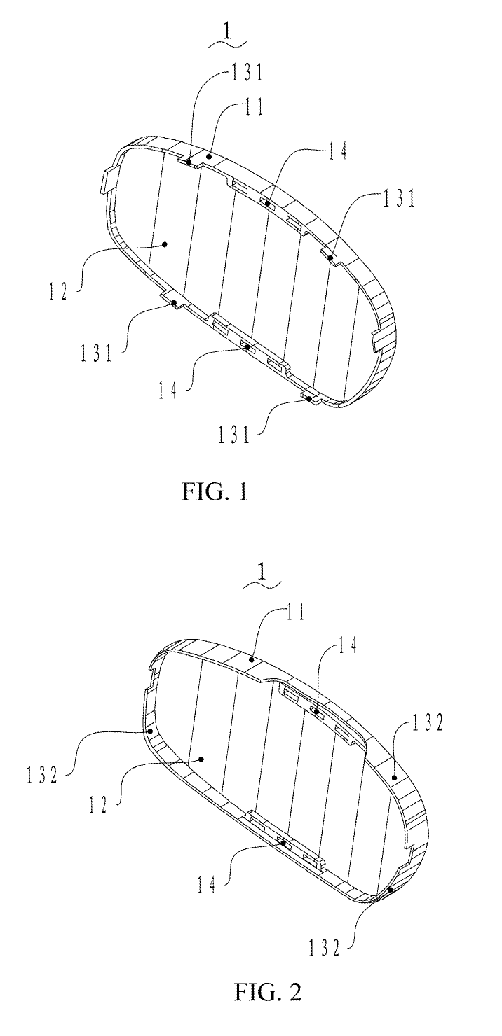

As shown in FIGS. 1 to 7, a magnetic pulling type free hanging frame 1 comprises at least a plastic ring 11 and the lens 12 contained in the plastic ring 11, the lens 12 is contained in the plastic ring 11, and then is connected to the main eyeglass frame 2 by fitting the plastic ring 11 with the main eyeglass frame 2, so that the functions of the main eyeglass frame work coordinating with the functions of the pulling type free hanging frame, then the environment light enters into the eyes after double filtering of the lenses of the pulling type free hanging frame and the main eyeglass frame, which satisfies the needs of light processing for the customers; this hanging frame uses plastic rings not only because plastic materials are light in weight, but also because the molding technique of plastic materials is simple and only one molding process is needed to get the desired structure so that the production cost of the hanging frame is low. The pulling type free hanging frame 1 also comprises at least a magnet 14, said magnet 14 is inlayed in said plastic ring 11, the plastic ring 11 has reserved containing chambers, and the magnet 14 can be pressed into the containing chamber directly, so installing the magnet 14 is easy and the installing depth is easy to control, then we can press the magnet into the plastic ring to the depth so that the surfaces of the magnet is below the surfaces of the plastic ring, which can protect the surfaces of the main eyeglass frame and ensure the appearance is not destroyed. A positioning mechanism (the positioning mechanism includes the positioning blocks 131 and the positioning ring 132) is used to coordinate with the main eyeglass frame 2 is set on the plastic ring 11, the positioning mechanism confines the main eyeglass frame in certain region, so the front lens and the back lens are placed closely, and the positioning mechanism coordinates with the magnetic force to firmly connect the pulling type free hanging frame and the main eyeglass frame.

To enhance the magnetic force, multiple magnets 14 are separately set in plastic ring 11; the multiple magnets are cylinder-shaped type, bar-shaped type, or other else familiar shape type. Preferably, at least three magnets 14 are evenly set on the top of the plastic ring 11, similarly, multiple magnets 14 are evenly set at the bottom of the plastic ring 11. The amount of the magnet 14 is decided by the weight of the pulling type free hanging frame and the required magnitude of the magnetic attraction force, if the weight of the pulling type free hanging frame is relatively large and the required magnetic attraction force is relatively large, relatively more magnets are set in the plastic ring, if the weight of the pulling type free hanging frame is relatively small and the required magnetic attraction force is normal, a small amount of magnets are set in the plastic ring,

The positioning mechanism of this invention includes multiple positioning blocks 131 or a positioning ring 132. The positioning blocks 131 are bumps separately distributed along the perimeter of the plastic ring 11, these positioning blocks 131 are surrounded to form a place area to contain the main eyeglass frame 2, and these positioning blocks and the magnetic force cooperate to firmly connect the pulling type free hanging frame 1 to the main eyeglass frame 2. Similarly, the positioning ring 132 is a bump continuously distributed along the perimeter of the plastic ring 11, the surrounded area of the positioning ring 132 is used to contain the main eyeglass frame 2, and the positioning ring and the magnetic force cooperate to firmly connect the pulling type free hanging frame 1 to the main eyeglass frame 2. In this invention, preferably, there are anti-split slices 133 set above the positioning blocks or the positioning ring, when the main eyeglass frame 2 is placed in the place area, these anti-split slices 133 are set outside the main eyeglass frame 2 to ensure the pulling type free hanging frame 1 would not separate from the main eyeglass frame 2.

If there is a single plastic ring in this invention, that is, the pulling type free hanging frame 1 has only one eye ring, as shown in FIGS. 1 and 2, connecting the pulling type free hanging frame 1 with only one eye ring to the main eyeglass frame 2 can satisfies the needs of the customers.

If there are two plastic rings 11 in this invention, that is, the pulling type free hanging frame 1 has a left plastic ring and a right plastic ring, the bridge 15 is set between the left and the right plastic ring, and connects the left and the right plastic ring, so that the left and the right plastic ring are connected together; the bridge 15 of the pulling type free hanging frame is coordinated with the bridge of the main eyeglass frame, and the bridge 15 of the pulling type free hanging frame is set above the bridge of the main eyeglass frame. The structure of the bridge 15 can be made in various forms including “-”type form and U type form; if the structure of the bridge is U type, the U type bridge is set above the bridge of the main eyeglass frame, and beside the connection effect, the bridge also has the protection effect from splitting apart.

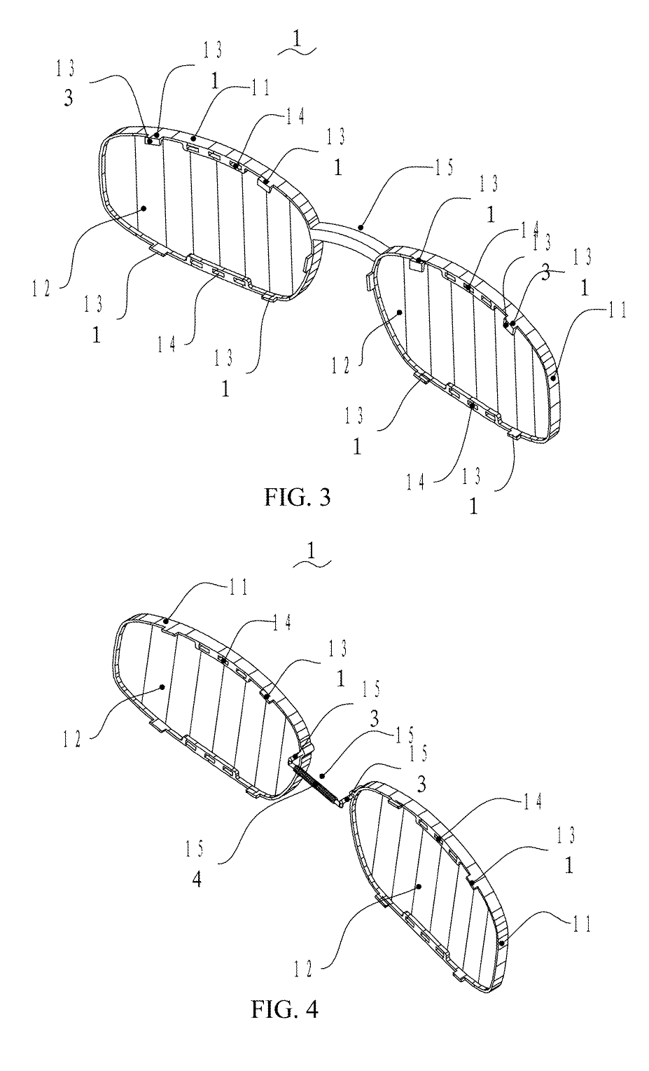

There are two connection types between the plastic rings and the bride: (1) elastic connection, in which direct plastic molding forms the one-body plastic rings and bridge (because of the elasticity of the plastic products, the pulling type free hanging frame and the main eyeglass frame have high matching degree, and the weight of the pulling type free hanging frame is reduced), as shown in FIG. 3; (2) hinge connection, in which the bridge made by a metal bar, and the two ends of the metal bars connect with the left and the right plastic ring separately, as shown in FIG. 6.

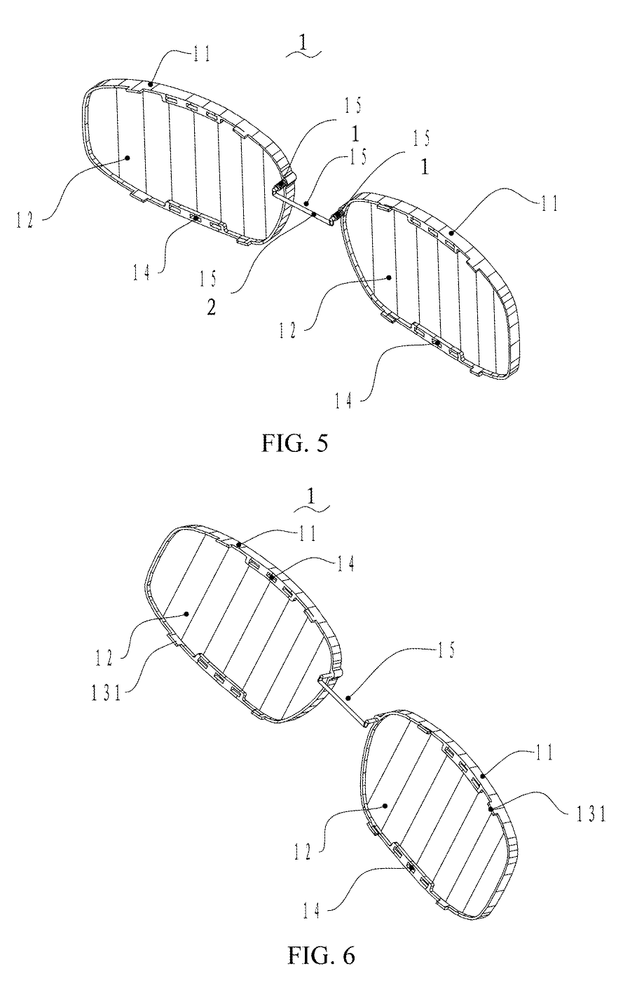

Elastic connection: (1) Said bridge 15 includes two spring posts 151 which are set separately on the two ends of the bridge 15 and a link bar 152 between the two spring posts 151; one end of the spring post 151 connects to the plastic ring 11 and the other end connects to the link bar 152; because of the spring posts 151, the left and the right plastic ring can move in a certain extent, which is convenient for installing the pulling type free hanging frame, so even there is some distortion in the main eyeglass frame 2, the pulling type free hanging frame 1 can have an appropriate corresponding distortion along with the shape of the bridge, as shown in FIG. 5. (2) Said bridge 15 includes two connection posts 153 which are set separately on the two ends of the bridge 15 and a connection spring 154 between the two connection posts 153; one end of the connection post 153 connects to the plastic ring 11 and the other end connects to the link bar 154; because of the connection spring 154, the left and the right plastic ring can move in a certain extent, which is convenient for installing the pulling type free hanging frame, so even there is some distortion in the main eyeglass frame 2, the pulling type free hanging frame 1 can have an appropriate corresponding distortion along with the shape of the bridge, as shown in FIG. 4. The pulling type free hanging frame with the elastic structure can fit with the main eyeglass frame according to different angles and arcs, so is very easy to use for the customers. So elastic connection totally solves the present easy split problem caused the mismatching between the arcs of the hanging frame and the arcs of the main eyeglass frame.

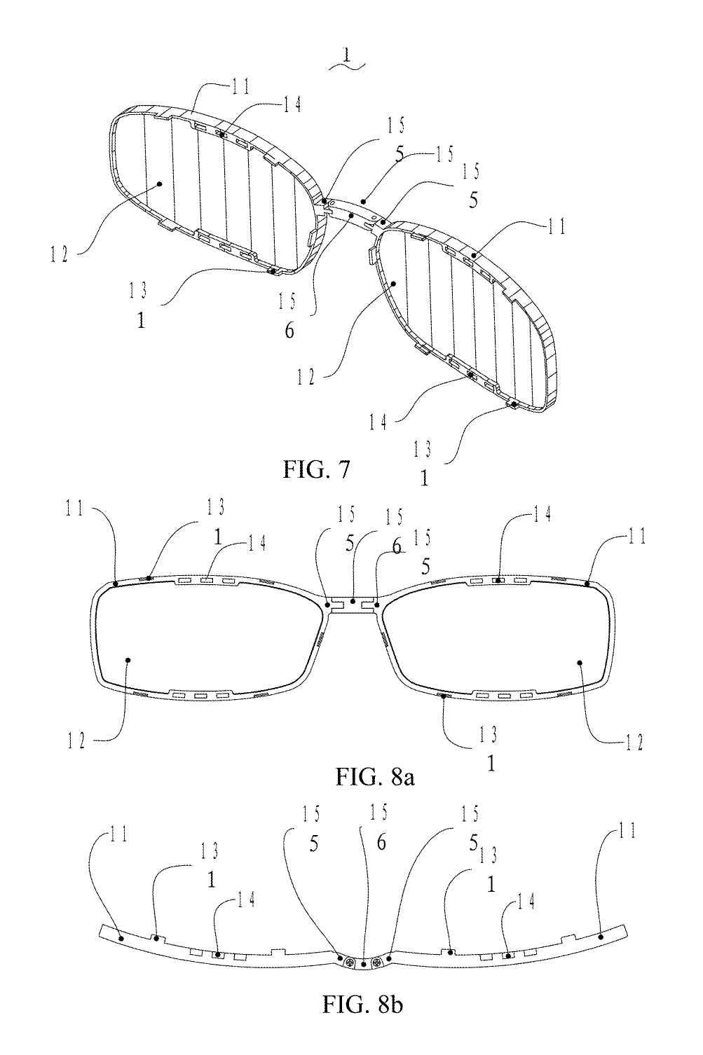

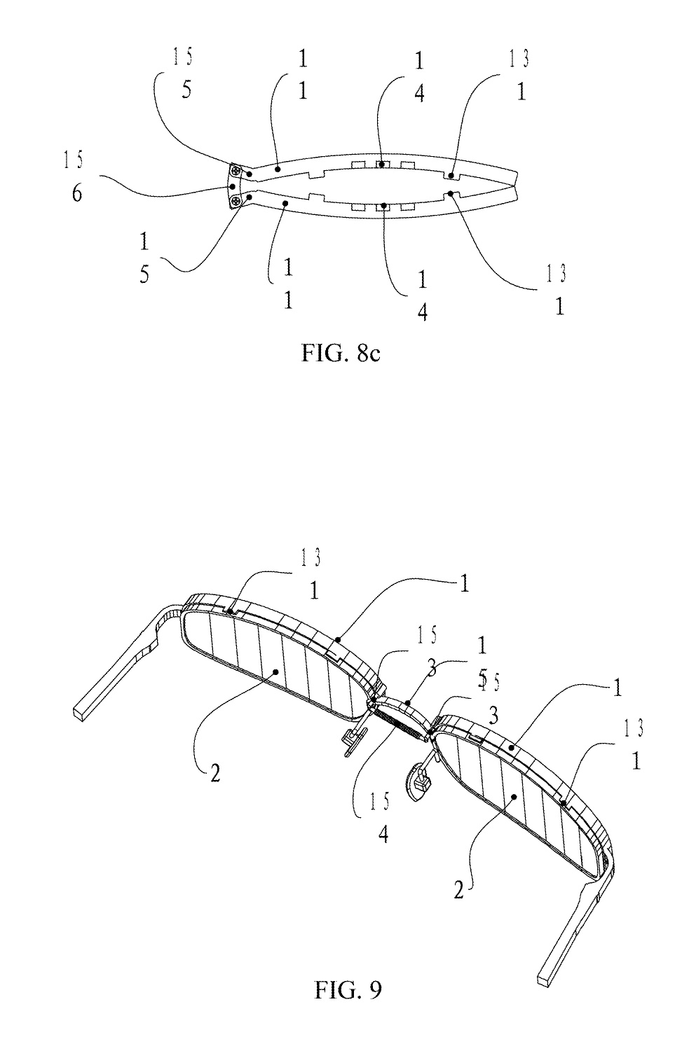

Hinge connection: Said bridge 15 includes two fixed blocks 155 which are set separately on the two ends of the bridge 15 and a connection block 156 between the two fixed blocks 155, and the two ends of said connection block 156 hinge separately to the free ends of the two fixed blocks 155. The left and the right plastic ring can move relative to the connection block 156, that is, the left and the right plastic ring can symmetrically fold back together, which is convenient for storage and transportation, as shown in FIG. 7 and FIG. 8.

This invention has a simple processing technique; making use of plastic ring helps reduce the weight of the hanging frame , that is, the overall weight of the glasses, and then reduce the pressure on the nose caused by the glasses; inlaying magnets in the ring easily provides enough magnetic force; the bridge has an elastic mechanism which provides a higher matching degree when the hanging frame is fixed to the main eyeglass frame, and the bridge has an articulated mechanism enable the plastic ring to symmetrically fold back together, so that the hanging frame takes less volume space for storage; and this pulling type free hanging frame can directly fits with the original eyeglass frames without installing any magnet in the eyeglass frames, so using this hanging frame to fit with the original eyeglass frames would not destroy the overall appearance.

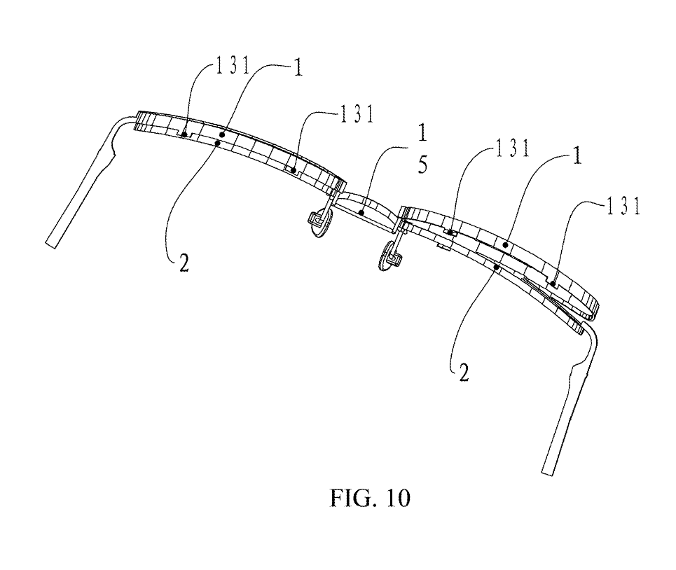

As shown in FIGS. 1 to 10, a pair of glasses comprises a main eyeglass frame with metal rim line and a magnetic pulling type free hanging frame; the magnetic pulling type free hanging frame fits with the main eyeglass frame. The magnetic pulling type free hanging frame 1 comprises at least a plastic ring 11 and the lens 12 contained in the plastic ring 11, the lens 12 is contained in the plastic ring 11, and then is connected to the main eyeglass frame 2 by fitting the plastic ring 11 with the main eyeglass frame 2, so that the functions of the main eyeglass frame work coordinating with the functions of the pulling type free hanging frame, then the environment light enters into the eyes after double filtering of the lenses of the pulling type free hanging frame and the main eyeglass frame, which satisfies the needs of light processing for the customers; this hanging frame uses plastic rings not only because plastic materials are light in weight, but also because the molding technique of plastic materials is simple and only one molding process is needed to get the desired structure so that the production cost of the hanging frame is low. The pulling type free hanging frame 1 also comprises at least a magnet 14, said magnet 14 is inlayed in said plastic ring 11, the plastic ring 11 has reserved containing chambers, and the magnet 14 can be pressed into the containing chamber directly, so installing the magnet 14 is easy and the installing depth is easy to control, then we can press the magnet into the plastic ring to the depth so that the surfaces of the magnet is below the surfaces of the plastic ring, which can protect the surfaces of the main eyeglass frame and ensure the appearance is not destroyed. A positioning mechanism (the positioning mechanism includes the positioning blocks 131 and the positioning ring 132) is used to coordinate with the main eyeglass frame 2 is set on the plastic ring 11, the positioning mechanism confines the main eyeglass frame in certain region, so the front lens and the back lens are placed closely, and the positioning mechanism coordinates with the magnetic force to firmly connect the pulling type free hanging frame and the main eyeglass frame.

To enhance the magnetic force, multiple magnets 14 are separately set in plastic ring 11; the multiple magnets are cylinder-shaped type, bar-shaped type, or other else familiar shape type. Preferably, at least three magnets 14 are evenly set on the top of the plastic ring 11, similarly, multiple magnets 14 are evenly set at the bottom of the plastic ring 11. The amount of the magnet 14 is decided by the weight of the pulling type free hanging frame and the required magnitude of the magnetic attraction force, if the weight of the pulling type free hanging frame is relatively large and the required magnetic attraction force is relatively large, relatively more magnets are set in the plastic ring, if the weight of the pulling type free hanging frame is relatively small and the required magnetic attraction force is normal, a small amount of magnets are set in the plastic ring,

The positioning mechanism of this invention includes multiple positioning blocks 131 or a positioning ring 132. The positioning blocks 131 are bumps separately distributed along the perimeter of the plastic ring 11, these positioning blocks 131 are surrounded to form a place area to contain the main eyeglass frame 2, and these positioning blocks and the magnetic force cooperate to firmly connect the pulling type free hanging frame 1 to the main eyeglass frame 2. Similarly, the positioning ring 132 is a bump continuously distributed along the perimeter of the plastic ring 11, the surrounded area of the positioning ring 132 is used to contain the main eyeglass frame 2, and the positioning ring and the magnetic force cooperate to firmly connect the pulling type free hanging frame 1 to the main eyeglass frame 2. In this invention, preferably, there are anti-split slices 133 set above the positioning blocks or the positioning ring, when the main eyeglass frame 2 is placed in the place area, these anti-split slices 133 are set outside the main eyeglass frame 2 to ensure the pulling type free hanging frame 1 would not separate from the main eyeglass frame 2.

If there is a single plastic ring in this invention, that is, the pulling type free hanging frame 1 has only one eye ring, as shown in FIGS. 1 and 2, connecting the pulling type free hanging frame 1 with only one eye ring to the main eyeglass frame 2 can satisfies the needs of the customers.

If there are two plastic rings 11 in this invention, that is, the pulling type free hanging frame 1 has a left plastic ring and a right plastic ring, the bridge 15 is set between the left and the right plastic ring, and connects the left and the right plastic ring, so that the left and the right plastic ring are connected together; the bridge 15 of the pulling type free hanging frame is coordinated with the bridge of the main eyeglass frame, and the bridge 15 of the pulling type free hanging frame is set above the bridge of the main eyeglass frame. The structure of the bridge 15 can be made in various forms including “-”type form and U type form; if the structure of the bridge is U type, the U type bridge is set above the bridge of the main eyeglass frame, and beside the connection effect, the bridge also has the protection effect from splitting apart.

There are two connection types between the plastic rings and the bride: (1) elastic connection, in which direct plastic molding forms the one-body plastic rings and bridge (because of the elasticity of the plastic products, the pulling type free hanging frame and the main eyeglass frame have high matching degree, and the weight of the pulling type free hanging frame is reduced), as shown in FIG. 3; (2) hinge connection, in which the bridge made by a metal bar, and the two ends of the metal bars connect with the left and the right plastic ring separately, as shown in FIG. 6.

Elastic connection: (1) Said bridge 15 includes two spring posts 151 which are set separately on the two ends of the bridge 15 and a link bar 152 between the two spring posts 151; one end of the spring post 151 connects to the plastic ring 11 and the other end connects to the link bar 152; because of the spring posts 151, the left and the right plastic ring can move in a certain extent, which is convenient for installing the pulling type free hanging frame, so even there is some distortion in the main eyeglass frame 2, the pulling type free hanging frame 1 can have an appropriate corresponding distortion along with the shape of the bridge, as shown in FIG. 5. (2) Said bridge 15 includes two connection posts 153 which are set separately on the two ends of the bridge 15 and a connection spring 154 between the two connection posts 153; one end of the connection post 153 connects to the plastic ring 11 and the other end connects to the link bar 154; because of the connection spring 154, the left and the right plastic ring can move in a certain extent, which is convenient for installing the pulling type free hanging frame, so even there is some distortion in the main eyeglass frame 2, the pulling type free hanging frame 1 can have an appropriate corresponding distortion along with the shape of the bridge, as shown in FIG. 4. The pulling type free hanging frame with the elastic structure can fit with the main eyeglass frame according to different angles and arcs, so is very easy to use for the customers. So elastic connection totally solves the present easy split problem caused the mismatching between the arcs of the hanging frame and the arcs of the main eyeglass frame.

Hinge connection: Said bridge 15 includes two fixed blocks 155 which are set separately on the two ends of the bridge 15 and a connection block 156 between the two fixed blocks 155, and the two ends of said connection block 156 hinge separately to the free ends of the two fixed blocks 155. The left and the right plastic ring can move relative to the connection block 156, that is, the left and the right plastic ring can symmetrically fold back together, which is convenient for storage and transportation, as shown in FIG. 7 and FIG. 8.

This invention has a simple processing technique; making use of plastic ring helps reduce the weight of the hanging frame , that is, the overall weight of the glasses, and then reduce the pressure on the nose caused by the glasses; inlaying magnets in the ring easily provides enough magnetic force; the bridge has an elastic mechanism which provides a higher matching degree when the hanging frame is fixed to the main eyeglass frame, and the bridge has an articulated mechanism enable the plastic ring to symmetrically fold back together, so that the hanging frame takes less volume space for storage; and this pulling type free hanging frame can directly fits with the original eyeglass frames without installing any magnet in the eyeglass frames, so using this hanging frame to fit with the original eyeglass frames would not destroy the overall appearance.

What is claimed is:

1. A magnetic pulling type free hanging frame comprising at least a plastic ring and the lens contained in said plastic ring; said plastic ring including a positioning mechanism which coordinates with the main eyeglass frame; the pulling type free hanging frame also including at least a magnet, said magnet inlaying in said plastic ring.

2. The magnetic pulling type free hanging frame of claim 1 wherein there are multiple said magnets which are separately set in said plastic ring.

3. The magnetic pulling type free hanging frame of claim 2 wherein said positioning mechanism contains multiple positioning blocks or a positioning ring.

4. The magnetic pulling type free hanging frame of any of claims 1 to 3 wherein the pulling type free hanging frame includes a bridge which is used to connect the two plastic rings.

5. The magnetic pulling type free hanging frame of claim 4 wherein said bridge includes an elastic mechanism and an articulated mechanism.

6. The magnetic pulling type free hanging frame of claim 5 wherein said bridge includes two spring posts which are set separately on the two ends of said bridge and a link bar between said two spring posts.

7. The magnetic pulling type free hanging frame of claim 5 wherein said bridge includes two connection posts which are set separately on the two ends of said bridge and a connection spring between said two connection posts.

8. The magnetic pulling type free hanging frame of claim 5 wherein said bridge includes two fixed blocks which are set separately on the two ends of said bridge and a connection block between said two fixed blocks, and the two ends of said connection block connect separately to the free ends of said two fixed blocks.

9. The magnetic pulling type free hanging frame of claim 4 wherein said bridge and said plastic ring are integrated into one body.

10. A pair of glasses comprising a main eyeglass frame with metal rim line and a said magnetic pulling type free hanging frame of any one of claims 1 to 9; said magnetic pulling type free hanging frame fits with said main eyeglass frame.
